(19) United States
(12) Patent Application Publication
(10) Pub. No.: US 2014/0350176 A1
(43) Pub. Date: Nov. 27, 2014

(54) Hydrophilic Silicone Gel Adhesives

(71) Applicant: Dow Corning Corporation, Midland, MI (US)

(72) Inventors: Mark David Fisher, Midland, MI (US); Roger A. Gibas, Bay City, MI (US); Laurie N. Kroupa, Delaware, OH (US); Kathryn E. Messner, Midland, MI (US); Do-lung Pan, Taoyuan Hsien (TW); Randall G. Schmidt, Midland, MI (US); Shengqing Xu, Midland, MI (US)

(73) Assignee: Dow Corning Taiwan Inc., Taipei (TW)

(21) Appl. No.: 14/366,742

(22) PCT Filed: Dec. 18, 2012
(86) PCT No.: PCT/US2012/070378

§ 371 Date: Jun. 19, 2014

Related U.S. Application Data
(60) Provisional application No. 61/578,826, filed on Dec. 21, 2011.

(51) Int. Cl. C09J 183/04; C08J 3/24

(52) U.S. Cl. CPC C09J 183/04; C08J 3/24
USPC 524/588

(57) ABSTRACT

The present invention relates to a method of preparing hydrophilic silicone gel adhesives by curing a silicone composition. The method includes forming the silicone composition by reacting a polyoxyethylene-organopolysiloxane copolymer having an average of at least 1 functional groups selected from, unsaturated hydrocarbon, hydroxyl, silanol, or combinations thereof and a polyoxyethylene-organopolysiloxane copolymer as cross-linker having an average of at least 2 silicon-bonded hydrogen atoms per molecule in the presence of a catalyst. The polyoxyethylene-organopolysiloxane copolymers react via hydrosilylation or coupling reaction.

### FIELD OF THE INVENTION

The present invention relates to novel hydrophilic silicone gel adhesives and methods of their preparation. The hydrophilic silicone gel adhesives can be used in medical applications demanding low or mild adhesion on solid substrates and low to mild hydrophilicity.

### BACKGROUND OF THE INVENTION

Silicone gels, rubbers, and elastomers are the terms generally used to describe elastic materials prepared by the crosslinking of linear polyorganosiloxanes. Gels, elastomers, and rubbers are differentiated by the extent of crosslinking within the siloxane network, by hardness, and elasticity. These materials may be used in medical wound dressings to treat most types of wounds safely. Studies have shown that silicone adhesives can be removed without causing trauma to the wound or to the surrounding skin or patient. Since silicone is inert, biocompatible, and has good gas permeability, it does not interact chemically with the wound or have any effect upon the cells responsible for the healing process. However, its hydrophobic property results in poor wettability by body liquids and uncomfortable feeling. Silicone adhesives may be used for neonatal care, medical device attachment, wound care, skin therapy, and scar management and the like.

Silicone adhesives are tacky to the touch, and at the same time they are generally easily removed and do not leave adhesive residue on most substrates. Due to their low liquid surface tension and slightly higher critical surface tension of wetting, silicone adhesives have an excellent ability to flow and wet-out, silicone adhesives conform to the uneven micro-surface of the skin, filling minute gaps and delivering a much broader contact area than traditional adhesives. Silicone adhesives spread easily to form films over substrates like skin and also over their own absorbed film. Moreover, they adhere to the skin securely, forming an immediate bond even on contoured areas of the body.

Silicone adhesives do not form a permanent bond. Their soft, rubbery behavior makes such silicone adhesives appropriate materials for contacting biological tissues by minimizing the risk of trauma at the interface. Silicone adhesives have properties such as low skin stripping force, gentle removability, and no adhesion to wound bed. Additionally, the skin cells will not lift off when the adhesive is removed, a factor that can damage the skin after repeated removal of traditional acrylic or rubber-based adhesives. Moreover, silicone adhesives do not lose adhesion force when removed from the skin; thus, devices and dressings utilizing such adhesives may be washed with water, air-dried, or reused if necessary. This allows their use in transdermal drug delivery and wound management applications to secure patches or dressings to the skin with minimum impact on the contacting area.

Due to their high permeability, silicones allow the diffusion of many substances such as gases (i.e., oxygen, carbon dioxide, water vapor) but also the diffusion of various actives (i.e., plant extract, drug, or even protein). Thus, silicones are used in personal care, skin topical applications or wound dressings due to their nonocclusive properties and no maceration. It also explains their use as adhesives or elastomers in controlled drug delivery systems. Moreover, due to their stability, silicones are easy to sterilize by steam or ethylene oxide (EO).

Conventional wound care products incorporate the use of polymeric foams, polymeric films, particulate and fibrous polymers, and/or non-woven and woven fabrics. Dressings with the right combination of these components promote wound healing by providing a moist environment, while removing excess exudate and toxic components, and further serve as a barrier to protect the wound from secondary bacterial infection.

There are several known silicone gel adhesives in the art that are useful in medical, personal care, house care, textile, electronics, coatings, and agriculture articles. However, the known adhesives do not have the appropriate balance of hydrophilicity, adhesion force, curing speed, and transparency properties. Therefore, what are needed in the art are silicone gel adhesives having low to mild adhesion force on solid substrates, low to mild hydrophilicity or water absorption, faster curing speed, and better transparency. The embodiments disclosed herein address that need.

### SUMMARY OF THE INVENTION

The present disclosure relates to silicone compositions cured into novel hydrophilic silicone gel adhesives having low or mild adhesion on solid substrates and low to mild hydrophilicity.

The silicone adhesive gels may be prepared by curing the product of a reaction between (a) a polyoxyethylene-organopolysiloxane copolymer having an average of at least one functional group selected from an unsaturated hydrocarbon, hydroxyl, silanol, or combinations thereof and (b) a polyoxyethylene-organopolysiloxane copolymer as a cross-linker having an average of at least 2 silicon-bonded hydrogen atoms per molecule in the presence of a catalyst. The reaction is either a hydrosilylation or a coupling reaction.

In another embodiment, preparation of the silicone adhesive gel method may include reacting a filler with the copolymers (a) and (b). The filler may be adapted to react with the copolymers (a) and/or (b) or, in an alternate embodiment, the filler may be adapted to not react with the copolymers (a) and/or (b). The filler may be a liquid or a solid material, or a combination of the two. The filler may include a polymer, small molecules, or solid particles.

The polyoxyethylene-organopolysiloxane copolymers (a) and (b) may have different molecular weights, different oxyethylene contents, and different organopolysiloxane units. The organopolysiloxane units of polyoxyethylene-organopolysiloxane copolymers may include an MQ, TD, MT, or MTD resin. The oxyethylene content in the polyoxyethylene-organopolysiloxane copolymers (a) and (b) may be from about 5 to about 95 percent by weight.

The silicone gel adhesive may have low or mild adhesion on solid substrates and low to mild hydrophilicity or water absorption. The silicone gel adhesive may exhibit water absorption lower than about 120 wt % as measured by sample immersion into water for 24 hours at about 25±2° C. The silicone gel adhesive may exhibit an adhesion force of less than about 2 kg/cm² on a polycarbonate substrate as measured by inserting the polycarbonate substrate into the silicone gel adhesive to a depth of 2 mm.

Additional aspects of the invention will be apparent to those of ordinary skill in the art in view of the detailed description of various embodiments, a brief description of which is provided below.

### DETAILED DESCRIPTION

This invention relates to hydrophilic silicone gel adhesives that have a low or mild adhesion on solid substrates and low to mild hydrophilicity or water absorption. The hydrophilic silicone gel adhesives may be prepared by curing a silicone composition prepared by mixing (a) a polyoxyethylene-organopolysiloxane copolymer having an average of at least one functional group selected from an unsaturated hydrocarbon, hydroxyl, silanol, or combinations thereof and (b) a polyoxyethylene-organopolysiloxane copolymer as a cross-linker having an average of at least 2 silicon-bonded hydrogen atoms per molecule in the presence of a catalyst. Reactants (a) and (b) react via hydrosilylation or a coupling reaction.

The organopolysiloxane (component (a)) and the SiH-containing organopolysiloxane (component (b)) may be present in any amount determined by one skilled in the art that would be sufficient to impart the desired properties of the silicone gel adhesive described herein. The components (a) and (b) may be mixed by any suitable technique.

The polyoxyethylene-organopolysiloxane copolymers (a) and (b) may include terminal groups that may be further defined as alkyl or aryl groups, and/or alkoxy groups exemplified by methoxy, ethoxy, or propoxy groups, or hydroxyl groups.

The polyoxyethylene-organopolysiloxane copolymer (component (a)) is an aliphatically unsaturated compound. Component (a) may have an average, per molecule, of one or more aliphatically unsaturated organic groups capable of undergoing a hydrosilylation or coupling reaction.

In various embodiments, the polyoxyethylene-organopolysiloxane copolymers (a) and (b) may have one of the following formulae (1), (2), or (3):

R¹₃SiO(R¹₂SiO)_{d}(R⁴SiO_{3/2})ₛ(SiO_{4/2})ₜ(R²HSiO)_{g}(R³R²SiO)_{e-g}SiR¹₃ (1)

R¹₃SiO(R¹₂SiO)_{d}(R⁴SiO_{3/2})ₛ(SiO_{4/2})ₜ(R²HSiO_{3/2})_{g}(R³R²SiO_{3/2})_{e-g}SiR¹₃ (2)

R¹₃SiO(R¹₂SiO)_{d}(R⁴SiO_{3/2})ₛ(SiO_{4/2})ₜ(R²HSiO_{n/n})_{g}(R³R²SiO_{n/n})_{e-g}SiR¹₃. (3)

Subscript “d” typically may have a value ranging from 0 to 2000. Subscript “s” typically may have a value ranging from 0 to 200. Subscript “t” typically may have a value ranging from 0 to 200. Subscript “e” typically may be 0 or a positive number. Alternatively, subscript “e” may have an average value ranging from 3 to 200. Subscript “g” typically may have a value ranging from 2 to 200. Subscript “n” typically may be a number greater than or equal to 1. R¹, R², and R⁴ may be independently selected from hydrogen atom and aliphatically saturated organic groups. Suitable exemplary monovalent organic groups include, but are not limited to, alkyl groups such as methyl, ethyl, propyl, pentyl, octyl, undecyl, and octadecyl; cycloalkyl groups such as cyclopentyl and cyclohexyl; and aryl groups such as phenyl, tolyl, xylyl, benzyl, and 2-phenylethyl.

R³ may have the following general formula (4):

CH₂CRCH₂O(CH₂CH₂O)ₙR¹ (4)

R is selected from a group that includes vinyl, allyl, methallyl, hydroxyl, hydroxylaryl and silanol.

In various embodiments, the organopolysiloxane units in (a) and/or (b) may be defined as a dialkylhydrogensilyl end-blocked polydialkylsiloxane, which may itself be further defined as dimethylhydrogensilyl end-blocked polydimethylsiloxane. The organopolysiloxane units in (a) and/or (b) may be further defined as a dimethylpolysiloxane capped at both molecular terminals with dimethylhydrogensiloxy groups; a dimethylpolysiloxane capped at both molecular terminals with methylphenylhydrogensiloxy groups; a copolymer of a methylphenylsiloxane and a dimethylsiloxane capped at both molecular terminals with dimethylhydrogensiloxy groups; a copolymer of a methylhydrogensiloxane and a dimethylsiloxane capped at both molecular terminals with trimethylsiloxy groups; a copolymer of diphenylsiloxane and dimethylsiloxane, a copolymer of a methylhydrogensiloxane and a dimethylsiloxane capped at both molecular terminals with dimethylhydrogensiloxy groups; a methyl(3,3,3-trifluoropropyl)polysiloxane capped at both molecular terminals with dimethylhydrogensiloxy groups; a copolymer of a methyl(3,3,3-trifluoropropyl)siloxane and a dimethylsiloxane capped at both molecular terminals with dimethylhydrogensiloxy groups; a copolymer of a methylhydrogensiloxane and a dimethylsiloxane capped at both molecular terminals with alkoxy groups; a copolymer of a methylhydrogensiloxane, a methylphenylsiloxane, and a dimethylsiloxane capped at both molecular terminals with alkoxy groups; or an organosiloxane copolymer composed of siloxane units represented by the following formulae: (CH₃)₃SiO_{1/2}, (CH₃)₂HSiO_{1/2}, CH₃SiO_{3/2}, (CH₃)₂SiO_{2/2}, CH₃PhSiO_{2/2} and Ph₂SiO_{2/2}.

Formulae (1)-(3) above may include the following building blocks:

M: R^{x}₃SiO_{1/2} in component (a) and R^{x}₂HSiO_{1/2} in component (b)

D: R^{x}₂SiO_{2/2} in component (a) or R^{x}HSiO_{2/2} in component (b);

T: R^{x}SiO_{3/2} in component (a) or HSiO_{3/2} in component (b); and

Q: SiO_{4/2} in both components (a) and (b).

Building block M represents a monofunctional unit. Building block D represents a difunctional unit. Building block T represents a trifunctional unit. Building block Q represents a tetrafunctional unit. The number of building blocks (M, D, T, Q) in the components (a) and (b) typically may range from 1 to 10,000, for instance 4 to 1,000.

Each of the open bonds from the oxygen atoms, designated as —O—, indicates a position where that building block may be bonded to another building block. Thus, it is through the oxygen atom that a first building block is bonded to a second or subsequent building block, the oxygen bonding either to another silicon atom or one of the R groups in the second or subsequent building block. When the oxygen atom is bonded to another silicon atom of the second building block, the oxygen atom represented in the first building block acts as the same oxygen atom represented in the second building block, thereby forming a Si—O—Si bond between the two building blocks.

The SiH-containing organopolysiloxane (component (b)) is known in the art as described, for example, in U.S. Pat. No. 3,983,298. The hydrogen atoms in this component may be located at terminal, pendant (non-terminal), or both terminal and pendant positions. The remaining silicon-bonded organic groups in this component are independently selected from monovalent hydrocarbon and monovalent halogenated hydrocarbon groups free of aliphatic unsaturation. These groups typically contain from 1 carbon to about 20 carbon atoms, alternatively from 1 carbon to 8 carbon atoms, and are exemplified by, but not limited to, alkyl such as methyl, ethyl, propyl, and butyl; aryl such as phenyl; and halogenated alkyl such as 3,3,3-trifluoropropyl. In one embodiment, at least about 50 percent of the organic groups in the organosiloxane containing silicon-bonded hydrogen atoms are methyl. The structure of the organosiloxane containing silicon-bonded hydrogen atoms is typically linear; however, it may contain some branching due to the presence of trifunctional siloxane units.

In one embodiment, the number of building blocks (M, D, T, Q) in the SiH-containing organopolysiloxanes in component (b) is from 1 to 1000. The SiH-containing organopolysiloxanes in component (b) must contain at least one M, at least one D, or at least one T building block. In other words, the SiH-containing organopolysiloxanes in component (b) cannot contain all Q building blocks. Therefore, if the SiH-containing organopolysiloxane in component (b) is comprised of only one building block, it can only be chosen from M, D, or T.

The SiH-containing organopolysiloxane in component (b) may be a linear or cyclic compound containing from 1 to about 10,000 (for instance, 1-1000, 1-200, or 1-100) of any combination of the following M, D, T, and Q building blocks. Examples of the SiH-containing organopolysiloxanes of component (b) that are useful in the methods described herein include polymeric organosiloxanes, such as (i) cyclic compounds containing between 3 and about 25 D building blocks (for instance, 3-10 or 4-6 D building blocks); or (ii) linear compounds containing two M building block that act an end blocks, and 2 to about 10,000 D building blocks (for instance, 2-1000, 2-200, 10-100, 50-80, 60-70, 2-20, or 5-10) between the end blocks. Linear SiH-containing organopolysiloxanes may be particularly useful in some embodiments, for example, those containing combination(s) of pendant and terminal SiH groups.

The organopolysiloxane units in (a) and (b) may include an MQ, TD, MT, or MTD resin. MQ resins in component (a) are represented by R^{x}₃SiO_{1/2} units and SiO_{4/2} units. MQ resins in component (b) are represented by R^{x}₂HSiO_{1/2} units and SiO_{4/2} units. In MQ resins, the molar ratio of M:Q can be from about 0.6:1 to about 1.9:1. Alternatively, the molar ratio of M:Q can be from about 0.6:1 to about 1.0:1.

TD resins in component (a) are represented by R^{x}SiO_{3/2} units and R^{x}₂SiO_{2/2} units. TD resins in component (b) are represented by HSiO_{3/2} units and R^{x}HSiO_{2/2} units. MT resins in component (a) are represented by R^{x}₃SiO_{1/2} units and R^{x}SiO_{3/2} units. MT resins in component (b) are represented by R^{x}₂HSiO_{1/2} units and HSiO_{3/2} units. MTD resins in component (a) are represented by R^{x}₃SiO_{1/2} units, R^{x}SiO_{3/2} units, and R^{x}₂SiO_{2/2}units. MTD resins in component (b) are represented by R^{x}₂HSiO_{1/2} units, HSiO_{3/2} units, and R^{x}HSiO_{2/2} units. Alternatively, the organopolysiloxane units in (a) and (b) may be represented by a combination of MQ, TD, MT, and/or MTD resins.

R^{x} designates any monovalent organic group exemplified by, but not limited to, monovalent hydrocarbon groups and monovalent halogenated hydrocarbon groups. Each R can be identical or different, as desired. Monovalent hydrocarbon groups are exemplified by, but not limited to, alkyl groups such as methyl, ethyl, propyl, pentyl, octyl, undecyl, and octadecyl; cycloalkyl groups such as cyclohexyl, and aryl groups such as phenyl, tolyl, xylyl, benzyl, and 2-phenylethyl. In one embodiment, the organopolysiloxane is free of halogen atoms. In another embodiment, the organopolysiloxane includes one or more halogen atoms.

At least one R^{x} group is an aliphatically unsaturated group such as an alkenyl group. Suitable alkenyl groups contain from 2 carbon atoms to about 6 carbon atoms and may be exemplified by, but not limited to, vinyl, allyl, and hexenyl. The alkenyl groups in this component may be located at terminal, pendant (non-terminal), or both terminal and pendant positions. The remaining silicon-bonded organic groups in the alkenyl-substituted polydiorganosiloxane are independently selected from monovalent hydrocarbon and monovalent halogenated hydrocarbon groups free of aliphatic unsaturation. These groups typically contain from 1 carbon atom to about 20 carbon atoms, alternatively from 1 carbon atom to 8 carbon atoms and are may be, but not limited to, alkyl such as methyl, ethyl, propyl, and butyl; aryl such as phenyl; and halogenated alkyl such as 3,3,3-trifluoropropyl. In one embodiment, at least about 50 percent of the organic groups in the alkenyl-substituted polydiorganosiloxane are methyl. The structure of the alkenyl-substituted polydiorganosiloxane is typically linear; however, it may contain some branching due to the presence of trifunctional siloxane units.

Other suitable R^{x} groups include, but are not limited to, acrylate functional groups such as acryloxyalkyl groups; methacrylate functional groups such as methacryloxyalkyl groups; cyanofunctional groups; monovalent hydrocarbon groups; and combinations thereof. The monovalent hydrocarbon groups may include alkyl groups such as methyl, ethyl, propyl, isopropyl, n-butyl, s-butyl, t-butyl, pentyl, neopentyl, octyl, undecyl, and octadecyl groups; cycloalkyl groups such as cyclohexyl groups; aryl groups such phenyl, tolyl, xylyl, benzyl, and 2-phenylethyl groups; halogenated hydrocarbon groups such as 3,3,3-trifluoropropyl, 3-chloropropyl, dichlorophenyl, and 6,6,6,5,5,4,4,3,3-nonafluorohexyl groups; and combinations thereof. The cyano-functional groups may include cyanoalkyl groups such as cyanoethyl and cyanopropyl groups, and combinations thereof.

R^{x} may also include alkyloxypoly(oxyalkyene) groups such as propyloxy(polyoxyethylene), propyloxypoly(oxypropylene) and propyloxy-poly(oxypropylene)-co-poly(oxyethylene) groups, halogen substituted alkyloxypoly(oxyalkylene) groups such as perfluoropropyloxy(polyoxyethylene), perfluoropropyloxypoly(oxypropylene) and perfluoropropyloxy-poly(oxypropylene) copoly(oxyethylene) groups, alkenyloxypoly(oxyalkyene) groups such as allyloxypoly(oxyethylene), allyloxypoly(oxypropylene) and allyloxy-poly(oxypropylene) copoly(oxyethylene) groups, alkoxy groups such as methoxy, ethoxy, n-propoxy, isopropoxy, n-butoxy and ethylhexyloxy groups, aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole groups, hindered aminoalkyl groups such as tetramethylpiperidinyl oxypropyl groups, epoxyalkyl groups such as 3-glycidoxypropyl, 2-(3,4,-epoxycyclohexyl)ethyl, and 5,6-epoxyhexyl groups, ester functional groups such as acetoxymethyl and benzoyloxypropyl groups, hydroxyl functional groups such as hydroxy and 2-hydroxyethyl groups, isocyanate and masked isocyanate functional groups such as 3-isocyanatopropyl, tris-3-propylisocyanurate, propyl-t-butylcarbamate, and propylethylcarbamate groups, aldehyde functional groups such as undecanal and butyraldehyde groups, anhydride functional groups such as 3-propyl succinic anhydride and 3-propyl maleic anhydride groups, carbonyl and carboxy functional groups such as 3-carboxypropyl, 2-carboxyethyl, and 10-carboxydecyl groups, functional groups of carboxyalkoxy, carboxamido, amidino, nitro, cyano, primary amino, secondary amino, acylamino, alkylthio, sulfoxide, sulfone, metal salts of carboxylic acids such as zinc, sodium, and potassium salts of 3-carboxypropyl and 2-carboxyethyl groups, and combinations thereof.

Particular examples of organopolysiloxanes units in component (a) include polydimethysiloxane-polymethylvinylsiloxane copolymers, hexenyldimethylsiloxy-terminated polydimethylsiloxane-polymethylhexenylsiloxane copolymers, hexenyldimethylsiloxy-terminated polydimethylsiloxane polymers, vinyldimethylsiloxy-terminated polydimethylsiloxane polymers, vinyl or hexenyldimethylsiloxy-terminated poly(dimethylsiloxane-silicate) copolymers, mixed trimethylsiloxy-vinyldimethylsiloxy terminated poly(dimethylsiloxane-vinylmethylsiloxane-silicate) copolymers, vinyl or hexenyldimethylsiloxy terminated poly(dimethylsiloxane-hydrocarbyl) copolymers, derivatives thereof, and combinations thereof. Functional groups may be present at any point in the organopolysiloxane, for example, in the middle of the polymer or as an end group(s). Typical functional groups, such as diorgano-, —OH, -vinyl, -hexenyl, -epoxy, and -amine may be used in the organopolysiloxanes contemplated herein. End groups such as Me₃, Ph₂Me, Me₂Ph, Ph₃ may or may not be present in the organopolysiloxane unit of component (a).

It should also be noted that other resins can also be added to the silicone composition contemplated herein. For example, organic resins could be added if desired. In one embodiment, for example, a vinyl-functional organic resin can be added.

The organopolysiloxane units in components (a) or (b) may further include a cyclic siloxane ring containing n atoms of silicon with n≧3 (e.g., n=3-6) including R^{y}₂SiO_{n/n}, R^{y}HSiO_{n,n}, (R^{y}₂SiO)ₙ, or (R^{y}HSiO)ₙ units, or a combination thereof. R^{y} designates any monovalent organic group. These monovalent organic groups are exemplified by, but not limited to, monovalent hydrocarbon groups and monovalent halogenated hydrocarbon groups. Monovalent hydrocarbon groups are exemplified by, but not limited to, alkyl groups such as methyl, ethyl, propyl, pentyl, octyl, undecyl, and octadecyl; cycloalkyl groups such as cyclohexyl, and aryl groups such as phenyl, tolyl, xylyl, benzyl, and 2-phenylethyl. In one embodiment, the organopolysiloxane units are free of halogen atoms. In another embodiment, the organopolysiloxane may include one or more halogen atoms.

The (a) and (b) polyoxyethylene-organopolysiloxane copolymers react via a hydrosilylation or coupling reaction in the presence of a catalyst. The catalysts are illustrated by any metal-containing catalyst or coupling catalyst which facilitates the reaction of silicon-bonded hydrogen atoms of (b) with the unsaturated hydrocarbon group on (a). The metal-containing catalysts are illustrated by ruthenium, rhodium, palladium, osmium, iridium, platinum, and the coupling catalysts are illustrated by metal hydroxide, tris(pentafluorophenyl)borane and potassium carbonate.

The catalysts facilitating the hydrosilylation reaction may be further illustrated by the following: chloroplatinic acid, alcohol-modified chloroplatinic acids, olefin complexes of chloroplatinic acid, complexes of chloroplatinic acid and divinyltetramethyldisiloxane, fine platinum particles adsorbed on carbon carriers, platinum supported on metal oxide carriers such as Pt(A1₂0₃), platinum black, platinum acetylacetonate, platinum(divinyltetramethyldisiloxane), platinum halides exemplified by PtC12, PtC14, Pt(CN)2, complexes of platinum halides with unsaturated compounds exemplified by ethylene, propylene, and organovinylsiloxanes, styrenehexamethyldiplatinum, and RhC13(Bu2S)3.

The catalysts facilitating the coupling reaction between SiH and hydroxyl or silanol through dehydrogen atoms may further include the platinum catalysts described as above, and metal hydroxide catalysts such as potassium hydroxide (KOH), metal salts such as potassium carbonate (K₂CO₃), and tris(pentafluorophenyl)borane (B(C₆F₅)₃).

The amount of catalyst that is used is not narrowly limited as long as there is a sufficient amount to accelerate a reaction between the unsaturated hydrocarbon group (a) and the SiH terminated organopolysiloxane of (b) at room temperature or at temperatures above room temperature. The exact necessary amount of this catalyst will depend on the particular catalyst utilized and is not easily predictable. However, for platinum-containing catalysts the amount can be as low as one weight part of platinum for every one million weight parts of components. The catalyst can be added in an amount from about 10 to about 120 weight parts per one million parts of components, but is typically added in an amount from about 10 to about 60 weight parts per one million parts of the polyoxyethylene-organopolysiloxane copolymer having an unsaturated organic group at each molecular terminal and the SiH terminated organopolysiloxane.

The reaction can be conducted near or in the presence of a solvent. The solvent can be an alcohol such as methanol, ethanol, isopropanol, butanol, or n-propanol, a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, a halogenated hydrocarbon such as dichloromethane, 1,1,1-trichloroethane or methylene chloride, chloroform, dimethyl sulfoxide, dimethyl acetonitrile, tetrahydrofuran, white spirits, mineral spirits, or naphtha.

The amount of solvent can be up to about 50 weight percent, but is typically from about 20 to about 50 weight percent, said weight percent being based on the total weight of components in the reaction. The solvent used during the reaction can be subsequently removed from the resulting hydrophilic silicone gel adhesive by various known methods. The silicone composition may then be cured into a silicone gel adhesive by any suitable curing methods known in the art, such as by heat or UV light.

Additional components can be added to the reaction which are known to enhance such reactions. These components include salts such as sodium acetate which have a buffering effect in combination with platinum catalysts. If desired, other components can be added to the silicone gel adhesive composition including, but not limited to, fillers, pigments, low-temperature cure inhibitors, additives for improving adhesion, chain extenders, pharmaceutical agents, drugs, cosmetic agents, natural extracts, fluids or other materials conventionally used in gels, silicone fluids, silicone waxes, silicone polyethers, and rheology modifiers such as thickening agents or thixotropic agents. If a filler is added, such a filler may be configured to react or to not react with the polyoxyethylene-organopolysiloxane copolymers (a) and (b). The filler may be a liquid, a solid, or a combination of the two. The filler may include polymers, small molecules in any form or shape, including solid particles, fibers, sheets, or plates.

The hydrophilic silicone gel adhesive may comprise a solid or, in the alternative, a porous foam with open cells or closed cells. The hydrophilic silicone gel is adapted to provide quick curing properties and high transparency.

In one embodiment, the hydrophilic silicone gel adhesives may have a water absorption lower than about 120 wt % as measured by sample immersion into water for 24 hours at about 25±2° C.

In one embodiment, the hydrophilic silicone gel adhesives may have an adhesion force of less than about 2 kg/cm², and more particularly about 7 to about 989 g/cm² on polycarbonate substrate as measured by inserting the polycarbonate substrate into the gel to a depth of 2 mm.

The adhesion force is calculated as the tacky force required for inserting a polycarbonate probe into the gel to a depth of 2 mm. More specifically, the method used to calculate adhesion utilizes a Universal TA.XT2 Texture Analyzer (commercially available from Texture Technologies Corp., of Scarsdale, N.Y.) or its equivalent and a polycarbonate (1 cm in diameter) round probe. The Texture Analyzer has a force capacity of 55 lbs. and moves the probe at a speed of 1.0 mm/s. The Trigger Value is 5 grams, the Option is set to repeat until count and to set count to 5, the Test Output is Peak, the force is measured in tacky force, and the container is a 4 oz. wide-mouth, round glass bottle. All measurements are made at 25±2␣C and 50±4% relative humidity. Even more specifically, samples of the gel are prepared, reacted, and stabilized at 25␣C±2␣C for at least ½ hour. A sample is then positioned on the test bed directly under the probe. The Universal TA.XT2 Texture Analyzer is then programmed with the aforementioned specific parameters according to the manufacturer's operating instructions. Five independent measurements are taken at different points on the surface of the gel. The median of the five independent measurements is reported. The test probe is wiped clean with a soft paper towel after each measurement is taken. The repeatability of the value reported (i.e., the maximum difference between two independent results) should be within 2 g/cm² in tacky force at a 95% confidence level. Typically, the thickness of the sample is sufficient to ensure that when the sample is compressed, the force measurement is not influenced by the bottom of the bottle or the surface of the test bed. When performing measurements, the probe is typically placed more than ½ inch from the side of the sample.

It is contemplated that the silicone compositions may be prepared as a multiple part (e.g., 2 part) composition, for example, when the composition will be stored for a relatively long period of time before use. In the multiple part composition, the catalyst is stored in a separate part from any ingredient having a silicon bonded hydrogen atom, for example component (b), and the various parts are combined shortly before use of the composition. These silicone compositions may also be stored as a multiple part composition when the hydrosilylation and/or the coupling catalyst is sealed into capsules or needs to be activated by heat, radiation, UV light, or other acceptable method. When the liquid composition is heated at an elevated temperature or exposed to radiation or UV light, the catalyst can be activated and the liquid may be cured into a gel or a solid.

The silicone gel adhesive compositions described herein may be used as the skin-facing layer of a medical device or wound dressing. The silicone gel adhesive compositions described herein may also be used as the skin-facing layer in various applications where suitable skin-facing adhesive materials are desired. Representative examples of additional skin-facing uses of the adhesive compositions described herein are in athletic apparel such as biking shorts and feminine hygiene products.

Other additives or agents commonly added to medical dressings may also be included in the dressing. For instance, the medical dressing may also include agents that provide a pain-relieving effect, antiseptic effect, help sterility, and speed healing. The agents may be added separately or impregnated into the silicone composition, absorbable substrate, or other component of the medical dressing. For instance, dressings are commonly impregnated with antiseptic chemicals, such as in boracic lint. In one embodiment, the medical dressing may include silver particles, either suspended in the adhesive gel or otherwise impregnated into the dressing, which can be used to impart antimicrobial properties into the dressing.

A medical dressing, as known to those of skill in the art, is an adjunct used by a person for application to a wound to promote healing and/or prevent further harm. A medical dressing is designed to be in direct contact with the wound, although, for the purposes of this application, direct contact on all areas of the wound is not necessary. Among other purposes, a medical dressing is designed to (a) stem bleeding and help to seal the wound to expedite the clotting process; (b) absorb exudate by soaking up blood, plasma and other fluids exuded from the wound; (c) ease pain of the wound; (d) debride the wound by removing the slough and foreign objects from the wound; (e) protect the wound from infection and mechanical damage; and (f) promote healing through granulation and epithelialization. A medical dressing comprising the silicone gel adhesive composition described herein, like other medical dressings, is designed to accomplish one or more of these design objectives.

It is also desirable for the medical dressing to retain a sufficient amount of moisture without retaining too much moisture, which can lead to an excessively wet environment for the wound which promotes the growth of bacteria, thus leading to wound maceration or other ailments. Balancing the moisture vapor is one way to gauge whether the dressing contains an appropriate amount of moisture. Other measures may also be used.

Compositions prepared according to the embodiments of the present invention can be used in various applications demanding low or mild adhesion on solid substrates and low to mild hydrophilicity or water absorption, for example, in the fields of medical, personal care, house care, textile, electronics, coatings, and agriculture. The compositions prepared according to the embodiments of the present invention can be particularly useful in medical and pharmaceutical applications, and more particularly, as cushioning materials, gentle adhesives for skin, wound interface materials for nonadherent wound dressings and foam dressings, and as a soft matrix for drug release.

### EXAMPLES

These examples are intended to illustrate the invention to one of ordinary skill in the art and should not be interpreted as limiting the scope of the invention set forth in the claims. All parts and percentages in the examples are on a weight basis and all measurements were indicated at about 25° C., unless indicated to the contrary.

As used herein,

1,1,3,3-tetramethyldisiloxane was obtained from Dow Corning Corporation (Midland, Mich.) and has the chemical formula: HSi(CH₃)₂—O—Si(CH₃)₂H;

“1,3-divinyltetramethyldisiloxane” was obtained from Dow Corning Corporation (Midland, Mich.) and has the chemical formula: CH₂═CHSi(CH₃)₂—O—Si(CH₃)₂CH═CH₂;

“AA-480R” was obtained from Nippon Oil & Fats Co., Ltd. (Tokyo, Japan) and has the chemical formula CH₂═CHCH₂O(CH₂CH₂O)₉CH₂CH═CH₂;

“D_{cyl-4}^{3H}D₈D_{cyl-4}^{3H}” was obtained from Dow Corning Corporation (Midland, Mich.) and has the chemical formula:

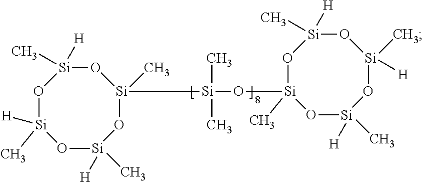

“DMUS-5” was obtained from Nippon Oil & Fats Co., Ltd. (Tokyo, Japan) and has the chemical formula: CH2═C(CH₃)CH₂O(CH₂CH₂O)₁₄CH₂(CH₃)C═CH₂;

“Karstedt's catalyst ” is a Platinum catalyst used as provided containing 0.52 wt % Platinum;

“MD₁₆₉D₂₃^{H}M” was obtained from Dow Corning Corporation (Midland, Mich.) and has the chemical formula:

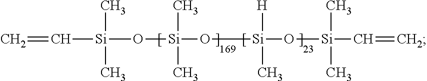

“Methylhydrogen terminated polydimethylsiloxane” (“M^{H}D₆M^{H}”) was obtained from Dow Corning Corporation (Midland, Mich.) and has the chemical formula:

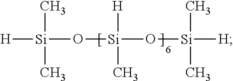

“M^{H}D ₁₇M^{H}” was obtained from Dow Corning Corporation (Midland, Mich.) and has the chemical formula:

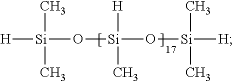

“MID ₁₀₀M^{H}” was obtained from Dow Corning Corporation (Midland, Mich.) and has the chemical formula:

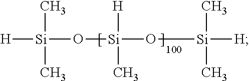

“M^{Vi}D₁₄₉M^{Vi}” was obtained from Dow Corning Corporation (Midland, Mich.) and has the chemical formula:

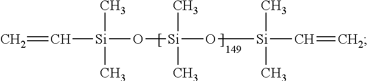

“PKA 5118” was obtained from Nippon Oil & Fats Co., Ltd. (Tokyo, Japan) and has the chemical formula: CH₂═CHCH₂O(CH₂CH₂O)₁₆CH₃;

“Platinum (IV) catalyst” is Speier's catalyst, H₂PtCl₆ into isopropanol;

“Q_{4.4}D^{H}₈” was obtained from Dow Corning Corporation (Midland, Mich.) and has the chemical formula:

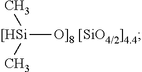

“THF (ACS grade)” is commercial grade tetrahydrofuran;

“Tocopherol 95” is a stabilizer and was obtained from Royal DSM N.V. (Heerlen, Netherlands);

“TPP” is triphenylphosphine;

“Uniox™ MA 500” (hereafter, MA 500) was obtained from Nippon Oil & Fats Co., Ltd. (Tokyo, Japan) and has the chemical formula: CH₂═CHCH₂O(CH₂CH₂O)₁₁CH₃.

Water Absorption Level & Tacky Force

Water absorption level was measured by immersing the silicone gel adhesive sample into DI water for 24 hours at room temperature. Tacky force was measured by Texture Analyzer, using polycarbonate (PC) plate with 10 mm diameter as the probe inserted in 2 mm gel depth.

Preparation of Raw Material Polyoxyethylene-Organopolysiloxane Copolymers (components (a) and (b))

### Example 1

### Preparation of α,ω-SiH Linear Si-PEO Copolymer

A typical process to synthesize the SiH terminated polyoxyethylene-organopolysiloxane copolymer is described as below. To a 1 L 3-neck flask with a reflux condenser and thermometer, 71.2 g of DMUS-5 (0.192 mol methallyl CH₂═C(CH₃)CH₂—), Karstedt's catalyst (15-20 ppm), Tocopherol 95 (130-200 ppm), and 155 g THF (tetrahydrofuran) were added to form a cloudy solution. 294.4 g (0.094 mol SiH) of M^{H}D₁₇M^{H} was then added to the flask. This cloudy mixture was allowed to react for 4 hours at refluxing temperature (77° C.) to form into one semi-transparent solution. Then, 3.11 g (0.046 mol SiH) of 1,1,3,3-tetramethyldisiloxane was added to keep this reaction for another 2 hours. 4-5 ppm of TPP in THF solution was added. Typically, the reaction mixture was changed from cloudy colorless into semi-clear. The product was obtained by stripping the mixture at a reduced pressure at 110° C. to remove THF and other volatile chemicals. A clear, pale yellow, low viscous liquid was collected; yield 357 g (97.6%). This sample has a molecular structure of α,ω-SiH linear Si-PEO copolymer, M^{H}-[D₁₇-Si(CH₃)₂CH₂CH(CH₃)CH₂O-(EO)₁₄]-M^{H}, hydride (H) content of 0.053%, and ethylene oxide content of 15.4 wt %.

### Example 2

### Preparation of α,ω-SiH Linear Si-EO Copolymer

Similar to example 1 above, α,ω-SiH linear Si-EO copolymer, M^{H}-[D6-Si(CH₃)₂CH₂CH(CH₃)CH₂O(EO)₁₄]-M^{H} and hydride (H) content of 0.003%, EO content of 41.5 wt %, was synthesized. Here, 84.45 g of DMUS-5 (0.228 mol CH₂═C(CH₃)CH₂—) was reacted with 84.45 g (0.233 mol SiH) of silicon hydride terminated polydimethylsiloxane M^{H}D₆M^{H} to obtain the semi-transparent, viscous liquid sample.

### Example 3

Preparation of SiH-Containing Silicone-Ethylene Oxide Copolymer with Polyethylene Oxide Grafted on Silicone Chain

To a 1 L 3-neck flask with a reflux condenser and thermometer, 63.6 g of PKA 5118 (0.0819 mol allyl CH₂═CHCH₂—), Karstedt's catalyst (15-20 ppm), Tocopherol 95 (130-200 ppm), and 230 g THF were added to form a cloudy solution. 265.2 g (0.435 mol SiH) of MD₁₆₉D₂₃^{H}M was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into semi-clear. The product was obtained by stripping the mixture at a reduced pressure at 95° C. to remove THF and other volatile chemicals. A clear, colorless, low viscous liquid was collected; yield was 400 g (95.5%). The synthesized sample had a molecular structure of the reactive SiH containing silicone-EO copolymer, MD₁₆₉D[CH₂CH₂CH₂O(EO₁₆)]₁₃D^{H}₁₀M, in which every molecule contained, on average, 10 SiH groups, with hydride (H) content of 0.0455% and EO content of 31.0 wt %.

### Example 4

Preparation of SiH-Containing Silicone-Ethylene Oxide Copolymer with Polyethylene Oxide Grafted on Silicone Chain

Reactive SiH-containing EO-branched silicone-EO copolymer was synthesized in a similar method to Example 3 above, but instead, by reaction of 163.9 g MA-500 (0.295 mol allyl CH₂═CHCH₂—) with 318.4 g (0.522 mol SiH) MD₁₆₉D₂₃^{H}M. The synthesized sample had the molecular structure MD₁₆₉D[CH₂CH₂CH₂O(EO₁₁)]₁₃D^{H}₁₀M, in which every molecule contained, on average, 10 SiH groups, with hydride (H) content of 0.0471% and EO content of 28.2 wt %.

### Example 5

Preparation of SiH-Containing Silicone-Ethylene Oxide Copolymer with Polyethylene Oxide Grafted on Silicone Chain

Reactive SiH-containing EO-branched silicone-EO copolymer was synthesized in a similar method to Example 3, but instead, by reaction of 66.7 g MA-500 (0.120 mol allyl CH₂═CHCH₂—) and 46.7 g of PKA 5118 (0.060 mol allyl CH₂═CHCH₂—) with 133.46 g (0.219 mol SiH) MD₁₆₉D₂₃^{H}M. This cloudy, viscous liquid sample had the molecular structure MD₁₆₉D[CH₂CH₂CH₂O(EO)₁₁]_{12.6}D[CH₂CH₂CH₂O(EO)₁₆]_{6.3}D^{H}_{4.1}M, in which every molecule contained, on average, 4.1 SiH groups, with hydride (H) content of 0.0156% and EO content of 38.8 wt %.

### Example 6

Preparation of SiH-Containing Silicone-EO Copolymer with PEO on Octopus Silicone Molecules

To a 500 mL 3-neck flask with a reflux condenser and thermometer, 43.6 g MA-500 (0.078 mol allyl CH₂═CHCH₂—), Karstedt's catalyst (15-20 ppm), Tocopherol 95 (130-200 ppm), and 58 g THF were added to form a cloudy solution. 31.1 g (0.124 mol SiH) of D_{cyl-4}^{3H}D₈D_{cyl-4}^{3H} was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A clear, colorless, low viscous liquid was collected; yield was 72 g (96%). This reactive silicone-EO octopus copolymer contained, on average, 3.8 SiH groups and 2.2 (EO)₁₁ groups on each molecule, with hydride (H) content of 0.0617% and EO content of 48.5 wt %.

### Example 7

Preparation of SiH-Containing Silicone-EO Copolymer with Light Crosslinked Network

To a 500 mL 3-neck flask with a reflux condenser and thermometer, 35.1 g MA-500 (0.063 mol allyl CH₂═CHCH₂—), 0.58 g DMUS-5 (0.00156 mol methallyl CH₂═C(CH₃)CH₂—), Karstedt's catalyst (15-20 ppm), Tocopherol 95 (130-200 ppm), and 46 g THF were added to form a cloudy solution. 25.1 g (0.100 mol SiH) of D_{cyl-4}^{3H}D₈D_{cyl-4}^{3H} was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A clear, colorless, low viscous liquid was collected; yield was 56 g (96%). This reactive silicone-EO network-like copolymer contained, on average, 3.9 SiH groups and 2.1 (EO)₁₁ on each molecule, with hydride (H) content of 0.0585% and EO content of 48.8 wt %.

### Example 8

Preparation of SiH-Containing Silicone-EO Copolymer with PEO on Silicone Chain

To a 1 L 3-neck flask with a reflux condenser and thermometer, 100.9 g MA-500 (0.182 mol allyl CH₂═CHCH₂—), Karstedt's catalyst (15-20 ppm), Tocopherol 95 (130-200 ppm), and 91 g THF were added to form a cloudy solution. 30.3 g (0.291 mol SiH) of Q_{4.4}D^{H}₈ liquid was then added to the flask. This cloudy mixture was allowed to react for 4 hours at refluxing temperature (76° C.) to form into one transparent solution. 4-5 ppm of TPP in THF solution was added, and the reaction mixture was changed from cloudy colorless into clear. The product was obtained by stripping the mixture at a reduced pressure at 114° C. to remove THF and other volatile chemicals. A clear, colorless, low viscous liquid was collected; yield was 128 g (96.2%). This reactive silicone-EO network-like copolymer contained, on average, 3 SiH groups and 5 (EO)₁₁ each molecule, with hydride (H) content of 0.0837% and EO content of 63.9 wt %.

### Example 9

Preparation of SiH-Containing Silicone-EO Copolymer with PEO on Silicone Chain

The SiH-containing silicone-EO copolymer with PEO on silicone chain was synthesized in a similar method to Example 8 above, but instead, by reaction of 31.31 g MA-500 (0.056 mol allyl CH₂═CHCH₂—) with 103.51 g Q_{4.4}D^{H}₈ (0.995 mol SiH) liquid. This cloudy, viscous liquid sample with reactive silicone-EO copolymer contained, on average, 7.5 SiH groups and 0.5 (EO)₁₁ on each molecule, with hydride (H) content of 0.696% and EO content of 19.3 wt %.

### Example 10

Preparation of Hydrophilic Polyether-Siloxane Copolymers with Functional Silicon-Vinyl (SiVi)

A typical process to synthesize the vinyl terminated Si-PEO is described as below. To a 1 L 3-neck flask with a reflux condenser and thermometer, 30.6 g of DMUS-5 (0.083 mol methallyl CH₂═C(CH₃)CH₂—), Speier's catalyst (15-20 ppm), tocopherol 95 (130-200 ppm), and 175 g THF (ACS grade) were added to form a cloudy solution. 362.2 g (0.094 mol SiH) of M^{H}D₁₀₀M^{H} was then added to the flask. This cloudy mixture was allowed to react for 4 hours at refluxing temperature (77° C.) to form semi-transparent solution. 3.62 g (0.039 mol silicone vinyl) of 1,3-divinyltetramethyldisiloxane was added to keep this reaction for another 2 hours. 4-5 ppm of TPP in THF solution was added. Typically, the reaction mixture was changed from cloudy colorless into semi-clear. The product was obtained by stripping the mixture at a reduced pressure at 110° C. to remove THF and other volatile chemicals. A hazy liquid with a middle viscosity was collected; yield 381 g (96.2%). This sample had a molecular structure of α,ω-vinyl linear Si-PEO copolymer, M^{Vi}[D₁₀₂-CH₂CH₂(CH₃)CH₂O-(EO)₁₄]₇M^{Vi} and Vi content of 0.081%, EO content of 6.2 wt %.

### Example 11

Preparation of Hydrophilic Polyether-Siloxane Copolymers with Functional Silicon-Vinyl (SiVi)

Hydrophilic polyethersiloxane copolymers with functional silicon-vinyl (SiVi) had a major component with a molecular structure of α,ω-vinyl linear siloxane-EO copolymer, M^{Vi}D₁₉-CH₂CH₂(CH₃)CH₂O-(EO)₁₄]₄M^{Vi} and Vi content of 0.51%, EO content of 22.2 wt %.

### Example 12

Preparation of Hydrophilic Polyethersiloxane Copolymers with Functional Silicon-Vinyl (SiVi)

Hydrophilic polyethersiloxane copolymers with functional silicon-vinyl (SiVi) with a molecular structure of α,ω-vinyl linear Si-PEO copolymer, M^{Vi}D₁₉-CH₂CH₂CH(CH₃)CH₂O-(EO)₁₆]_{23.7}M^{Vi} and Vi content of 0.098%, EO content of 26.4 wt %.

Preparation of Silicone Gel Adhesives

### Example 13

### Formulation (in Grams):

| | |
|---|---|
| MD₁₆₉D[CH₂CH₂CH₂O(EO₁₆)]₁₃D^{H}₁₀M | 100 |
| (synthesized in ex. 3 above) | |
| M^{Vi}D₁₄₉M^{Vi} | 8.74 |
| AA-480R | 1.28 |
| Karstedt's catalyst | 0.5 |

### Parameters & Gel Properties:

At 120° C., the liquid was cured into a white, unclear, tacky gel.
In the gel formulation, [SiH]/[CH₂═CH—] ratio was 6.8 mol/mol.
In the gel formulation, PEO content was 28.9 wt %.
The gel had a tacky force of 15 g/cm² (vs. 88.4 g for dimethylvinyl-terminated dimethyl siloxane).
The gel had a water absorption level of 87 wt %.

### Example 14

### Formulation (in Grams):

| | |
|---|---|
| MD₁₆₉D[CH₂CH₂CH₂O(EO₁₆)]₁₃D^{H}₁₀M | 100 |
| (synthesized in ex. 3 above) | |
| M^{Vi}D₁₄₉M^{Vi} | 12.8 |
| CH₂═C(CH₃)CH₂O(EO)₂₀(CH(CH₃)CH₂O)₃₆CH₂(CH₃)C═CH₂ | 2.8 |
| Karstedt's catalyst | 0.5 |

### Parameters & Gel Properties

At 120° C., the liquid was cured into a white, unclear, tacky gel.
In the gel formulation, [SiH]/[CH₂═CH—] ratio was 11.4 mol/mol.
In the gel formulation, PEO content was 28.0 wt %.
The gel had a tacky force of 96 g/cm².
The gel had a water absorption level of 115 wt %.

### Example 15

### Formulation (in Grams):

| | |
|---|---|
| MD₁₆₉D[CH₂CH₂CH₂O(EO₁₁)]_{12.6}D[CH₂CH₂CH₂O(EO₁₆)]_{6.3}D^{H}_{4.1}M | 100 |
| (synthesized in ex. 5 above) | |
| AA-480R | 4.1 |
| Karstedt's catalyst | 0.6 |

### Parameters & Gel Properties

At 120° C., the liquid was cured into a colorless, clear, tacky gel.
In the gel formulation, [SiH]/[CH₂═CH—] ratio was 0.94 mol/mol.
In the gel formulation, PEO content was 41.0 wt %.
The gel had a tacky force of: 450 g/cm².
The gel had a water absorption level of: 101 wt %.

### Example 16

### Formulation (in Grams):

| | |
|---|---|
| M^{Vi}[D₁₀₂—CH₂CH₂(CH₃)CH₂O—(EO)₁₄]₇M^{Vi} | 100 |
| (synthesized in ex. 10 above) | |
| MD₁₆₉D[CH₂CH₂CH₂O(EO₁₆)]₁₃D^{H}₁₀M | 20 |
| (synthesized in ex. 3 above) | |
| Karstedt's catalyst | 1.0 |

### Parameters & Gel Properties:

At 120° C., the liquid was cured into a white, cloudy, tacky gel.
In the gel formulation, [SiH]/[CH₂═CH—] ratio was 3.0 mol/mol.
In the gel formulation, PEO content was 10.3 wt %.
The gel had a tacky force of 251 g/cm².
The gel had a water absorption level of 7.4 wt %.

### Example 17

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| MD₁₆₉D[CH₂CH₂CH₂O(EO₁₁)]₁₃D^{H}₁₀M | 8.4 |
| (synthesized in ex. 4 above) | |
| Karstedt's catalyst | 0.7 |

### Parameters & Gel Properties:

At 120° C., the liquid was cured into a white, cloudy, tacky gel.
In the gel formulation, [SiH]/[CH₂═CH—] ratio was 0.21 mol/mol.
In the gel formulation, PEO content was 22.7 wt %.
The gel had a tacky force of 116 g/cm².
The gel had a water absorption level of 11.3 wt %.

### Example 18

### Formulation (in Grams):

| | |
|---|---|
| M^{Vi}[D₁₉—CH₂CH₂CH(CH₃)CH₂O—(EO)₁₆]_{23.7}M^{Vi} | 100 |
| (synthesized in ex. 12 above) | |
| MD₁₆₉D[CH₂CH₂CH₂O(EO₁₆)]₁₃D^{H}₁₀M | 8.1 |
| (synthesized in ex. 3 above) | |
| Karstedt's catalyst | 0.6 |

### Parameters & Gel Properties:

At 120° C., the liquid was cured into a clear, slightly yellow, tacky gel.
In the gel formulation, [SiH]/[CH₂═CH—] ratio was 1.02 mol/mol
In the gel formulation, PEO content was 25.6 wt %.
The gel had a tacky force of 73 g/cm².
The gel had a water absorption level of 19.2 wt %.

### Example 19

### Formulation (in Grams):

| | |
|---|---|
| M^{Vi}[D₁₀₂—CH₂CH₂(CH₃)CH₂O—(EO)₁₄]₇M^{Vi} | 100 |
| (synthesized in ex. 10 above) | |
| M^{H}—[D₁₇—Si(CH₃)₂CH₂CH(CH₃)CH₂O—(EO)₁₄]—M^{H} | 7.8 |
| (synthesized in ex. 1 above) | |
| MD₁₆₉D[CH₂CH₂CH₂O(EO₁₆)]₁₃D^{H}₁₀M | 19.7 |
| (synthesized in ex. 3 above) | |
| Karstedt's catalyst | 1.4 |

### Parameters & Gel Properties:

At 120° C., the liquid was cured into white, cloudy, high tacky gel.
In the gel formulation, [SiH]/[CH₂═CH—]=4.39 mol/mol.
In the gel formulation, PEO content was 10.6 wt %.
The gel had a tacky force of 989 g/cm²
The gel had a water absorption level of 14.1 wt %.

### Example 20

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| SiH containing silicone synthesized in ex. 6 above | 6.8 |
| Karstedt's catalyst | 1.1 |

### Parameters & Gel Properties:

At 120° C., the liquid was cured into a white, cloudy, high tacky gel.
In the gel formulation, [SiH]/[CH₂═CH—] ratio was 0.22 mol/mol.
In the gel formulation, PEO content was 23.9 wt %.
The gel had a tacky force of 1550 g/cm².
The gel had a water absorption level of 14.5 wt %.

### Example 21

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| M^{H}—[D₁₇—Si(CH₃)₂CH₂CH(CH₃)CH₂O—(EO)₁₄]—M^{H} | 15.0 |
| (synthesized in ex. 1 above) | |
| SiH containing silicone synthesized in Example 7 above | 8.85 |
| Karstedt's catalyst | 1.5 |

### Parameters & Gel Properties:

At 120° C., the liquid was cured into a yellow, cloudy, foamy, low tacky force gel.
In the gel formulation, [SiH]/[CH₂═CH—] ratio was 0.70 mol/mol.
In the gel formulation, PEO content was 23.3 wt %.
The gel had a tacky force of 70 g/cm².
The gel had a water absorption level of 25.1 wt %.

### Example 22

### Formulation (in Grams):

| | |
|---|---|
| M^{Vi}[D₁₀₂—CH₂CH₂(CH₃)CH₂O—(EO)₁₄]₇M^{Vi} | 100 |
| (synthesized in ex. 10 above) | |
| SiH containing silicone-EO copolymer synthesized in ex. 9 above | 7.5 |
| Karstedt's catalyst | 1.2 |

### Parameters & Gel Properties:

At 120° C., the liquid was cured into a white, cloudy, slightly tacky gel.
In the gel formulation, [SiH]/[CH₂═CH—] ratio was 29.7 mol/mol.
In the gel formulation, PEO content was 7.09 wt %.
The gel had a tacky force of 7 g/cm².
The gel had a water absorption level of 6.6 wt %.

### Example 23

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| Q_{4.4}D^{H}₅D(CH₂CH₂CH₂O(EO)₁₁CH₃)₃ | 7.70 |
| (synthesized in ex. 8 above) | |
| Karstedt's catalyst | 1.3 |

### Parameters & Gel Properties:

At 120° C., the liquid was cured into a white, cloudy, tacky gel.
In the gel formulation, [SiH]/[CH₂═CH—] ratio was 0.34 mol/mol.
In the gel formulation, PEO content was 25.2 wt %.
The gel had a tacky force of 327 g/cm².
The gel had a water absorption level of 19.9 wt %.

### Example 24

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| M^{H}—[D₁₇—Si(CH₃)₂CH₂CH(CH₃)CH₂O—(EO)₁₄]—M^{H} | 15.1 |
| (synthesized in ex. 1 above) | |
| Q_{4.4}D^{H}₅D(CH₂CH₂CH₂O(EO)₁₁CH₃)₃ | 7.1 |
| (synthesized in ex. 8 above) | |
| Karstedt's catalyst | 1.6 |

### Parameters & Gel Properties:

At 120° C., the liquid was cured into a white, cloudy, tacky gel.
In the gel formulation, [SiH]/[CH₂═CH—] ratio was 0.74 mol/mol.
In the gel formulation, PEO content was 23.8 wt %.
The gel had a tacky force of 519 g/cm².
The gel had a water absorption level of 20.2 wt %.

### Example 25

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| M^{H}—[D₁₇—Si(CH₃)₂CH₂CH(CH₃)CH₂O—(EO)₁₄]—M^{H} | 15.8 |
| (synthesized in ex. 1 above) | |
| SiH-containing silicone-EO copolymer synthesized in ex. 6 above | 7.7 |
| Karstedt's catalyst | 1.3 |

### Parameters & Gel Properties:

At 120° C., the liquid was cured into a white, cloudy, tacky gel.
In the gel formulation, [SiH]/[CH₂═CH—] ratio was 0.75 mol/mol.
In the gel formulation, PEO content was 23.1 wt %.
The gel had a tacky force of 217 g/cm².
The gel had a water absorption level of 31.7 wt %.

### Example 26

### Formulation (in Grams):

| | |
|---|---|
| M^{Vi}[D₁₉—CH₂CH₂(CH₃)CH₂O—(EO)₁₄]₄M^{Vi} | 100 |
| (synthesized in ex. 11 above) | |
| M^{H}—[D₆—Si(CH₃)₂CH₂CH(CH₃)CH₂O(EO)₁₄]_{45.4}—M^{H} | 16.3 |
| (synthesized in ex. 2 above) | |
| SiH-containing silicone-EO copolymer synthesized in ex. 8 above | 7.5 |
| Karstedt's catalyst | 1.3 |

### Parameters & Gel Properties:

At 120° C., the liquid was cured into a yellow, cloudy, foamy, tacky gel.
In the gel formulation, [SiH]/[CH₂═CH—] ratio was 0.36 mol/mol.
In the gel formulation, PEO content was 27.0 wt %.
The gel had a tacky force of 123 g/cm².
The gel had a water absorption level of 25.5 wt %.

While the invention is susceptible to various modifications and alternative forms, specific embodiments have been shown by way of example in the examples and described in detail herein. It should be understood, however, that the invention is not intended to be limited to the particular forms disclosed. Rather, the invention is to cover all modifications, equivalents, and alternatives falling within the spirit and scope of the invention as defined by the appended claims.

1. A silicone composition that can be coated onto a substrate comprising a hydrophilic silicone gel adhesive prepared by curing a first silicone composition comprising:
(a) a polyoxyethylene-organopolysiloxane copolymer having an average of at least 1 functional group selected from
(i) unsaturated hydrocarbon;
(ii) hydroxyl;
(iii) silanol; or
(iv) any combination of (i), (ii), or (iii); and
(b) a polyoxyethylene-organopolysiloxane copolymer as cross-linker having an average of at least 2 silicon-bonded hydrogen atoms per molecule,
wherein (a) and (b) react via hydrosilylation or coupling reaction in the presence of a catalyst.

2. The silicone composition of claim 1, wherein the catalyst is a metal-containing catalyst selected from platinum, rhodium, ruthenium, palladium, osmium, and iridium.

3. The silicone composition of claim 1, wherein organopolysiloxane units in (a) and/or (b) comprise a resin, wherein the resin is an MQ, TD, MT, or MTD resin, wherein
M is R^{x}₃SiO_{1/2} or R^{x}₂HSiO_{1/2};
D is R^{x}₂SiO_{2/2} or R^{x}HSiO_{2/2};
T is R^{x}SiO_{3/2} or HSiO_{3/2}; and
Q is SiO_{4/2},
wherein R^{x} is a monovalent organic group.

4. The silicone composition of claim 3, wherein R^{x} is alkyl, aryl, alkoxy, cycloalkyl, epoxyalkyl, epoxycyclohexyl, acryloxylalkyl, methacryloxylalkyl, carboxylalkyl, chloroalkyl, fluoroalkyl, or aminoalkyl.

5. The silicone composition of claim 1, wherein (a) and/or (b) include a mixture of polymerizable hybrid polysiloxanes having different molecular weights, different oxyethylene contents, different oranopolysiloxane units, or any combinations thereof.

6. The silicone composition of claim 1, wherein the oxyethylene content in compounds (a) and (b) is in an amount of from about 5 to about 95 weight percent in the total weight.

7. The silicone composition of claim 1, wherein the compounds (a) and (b) have a general formula:
R¹₃SiO(R¹₂SiO)_{d}(R⁴SiO_{3/2})ₛ(SiO_{4/2})ₜ(R²HSiO)_{g}(R³R²SiO)_{e-g}SiR¹₃, (1)
R¹₃SiO(R¹₂SiO)_{d}(R⁴SiO_{3/2})ₛ(SiO_{4/2})ₜ(R²HSiO_{3/2})_{g}(R³R²SiO_{3/2})_{e-g}SiR¹₃, (2)
R¹₃SiO(R¹₂SiO)_{d}(R⁴SiO_{3/2})ₛ(SiO_{4/2})ₜ(R²HSiO_{n/n})_{g}(R³R²SiO_{n/n})_{e-g}SiR¹₃, (3)
wherein d is 0-2000; s is 0-200; t is 0-200; e is 3-200; g is 2-200; n≧1; R¹, R², and R⁴ are independently selected from hydrogen atom or monovalent organic groups; and R³ has a general formula:
CH₂CRCH₂O(CH₂CH₂O)ₙR¹, (4)
wherein R is vinyl, allyl, methallyl, hydroxyl, hydroxylaryl, or silanol.

8. The silicone composition of claim 1, wherein the hydrophilic silicone gel adhesive optionally includes a solid or a porous foam with open cells or closed cells.

9. The silicone composition of claim 8, further comprising an adhesion force of less than about 2 kg/cm² on polycarbonate substrate as measured by inserting the polycarbonate substrate into the gel to a depth of 2 mm.

10. A method of preparing a hydrophilic silicone gel adhesive by curing a silicone composition prepared by reacting:
(a) a polyoxyethylene-organopolysiloxane copolymer having an average of at least 1 functional groups selected from
(i) unsaturated hydrocarbon;
(ii) hydroxyl;
(iii) silanol; or
(iv) any combination of (i), (ii), or (iii);
(b) a polyoxyethylene-organopolysiloxane copolymer as cross-linker having an average of at least 2 silicon-bonded hydrogen atoms per molecule;
(c) a catalyst; and
(d) a filler.

11. The method of claim 10, wherein the filler is a polymer or small molecules, the filler being configured to react with compound (a) and/or compound (b).

12. The method of claim 10, wherein the filler is a polymer or small molecules, the filler being configured to not react with compound (a) and/or compound (b).

13. The method of claim 10, wherein the filler is
(i) a liquid;
(ii) a solid; or
(iii) any combination of (i) and (ii).

14. The method of claim 10, wherein the filler is
(i) particles;
(ii) fibers;
(iii) sheets; or
(iv) any combination of (i), (ii) and (iii).

15. The method of claim 10, wherein the compounds (a) and (b) have a general formula:
R¹₃SiO(R¹₂SiO)_{d}(R⁴SiO_{3/2})ₛ(SiO_{4/2})ₜ(R²HSiO)_{g}(R³R²SiO)_{e-g}SiR¹₃, or (1)
R¹₃SiO(R¹₂SiO)_{d}(R⁴SiO_{3/2})ₛ(SiO_{4/2})ₜ(R²HSiO_{3/2})_{g}(R³R²SiO_{3/2})_{e-g}SiR¹₃, or (2)
R¹₃SiO(R¹₂SiO)_{d}(R⁴SiO_{3/2})ₛ(SiO_{4/2})ₜ(R²HSiO_{n/n})_{g}(R³ R²SiO_{n/n})_{e-g}SiR¹₃, (3)
wherein d is 0-2000; s is 0-200; t is 0-200; e is 3-200; g is 2-200; n≧1; R¹, R², and R⁴ are independently selected from hydrogen atom or monovalent organic groups; and R³ has a general formula:
CH₂CRCH₂O(CH₂CH₂O)R¹
wherein R is vinyl, allyl, methallyl, hydroxyl, hydroxylaryl, or silanol.

16. The silicone composition of claim 1, wherein additional units may be introduced into compounds (a) and (b).

17. The silicone composition of claim 1, wherein the catalyst is a coupling catalyst selected from tris(pentafluorophenyl)borane, potassium carbonate, or any combination thereof.

18. The silicone composition of claim 6, wherein the oxyethylene content in compounds (a) and (b) is in an amount of from about 6 to about 70 weight percent in the total weight.

19. The silicone composition of claim 8, further comprising a water absorption lower than about 120 wt % as measured by sample immersion into water for 24 hours at about 25±2° C.
